(19) United States
(12) Patent Application Publication
(10) Pub. No.: US 2006/0269094 A1
(43) Pub. Date: Nov. 30, 2006

(54) Speaker

(75) Inventor: Toshifumi Kato, Tendo (JP)

Correspondence Address: SUGHRUE MION, PLLC, 2100 PENNSYLVANIA AVENUE, N.W., SUITE 800, WASHINGTON, DC, 20037, US

(73) Assignees: PIONEER CORPORATION; TOHOKU PIONEER CORPORATION

(21) Appl. No.: 11/431,618

(22) Filed: May 11, 2006

(30) Foreign Application Priority Data
May 31, 2005 (JP) 2005-158694

(51) Int. Cl. H04R 9/06

(52) U.S. Cl. 381/410

(57) ABSTRACT

A speaker includes a diaphragm made of metal which vibrates to generate a sound; a voice coil for vibrating the diaphragm by being supplied with a voice current; a voice coil bobbin around which the voice coil is wound; a damper for supporting the voice coil bobbin; a magnetic circuit unit for vibrating the diaphragm in cooperation with the voice coil; and a brocaded thread wire for supplying the voice current to the voice coil. The brocaded thread wire is passed through a through hole formed in an inner edge part of the damper in the proximity of the voice coil bobbin. A connection part for connecting the brocaded thread wire to the voice coil is arranged on an outer peripheral surface of the voice coil bobbin and the connection part is arranged nearer to the magnetic circuit unit than the damper is.

### BACKGROUND OF THE INVENTION

(1) Field of the Invention

The present invention relates to a speaker for use in various acoustic instruments and so on.

(2) Description of the Related Art

As shown in FIGS. 1 and 2, a conventional speaker 101 used so far includes a vibration unit 106, magnetic circuit unit 107 for generating a sound by vibrating the vibration unit 106, and damper 111. The vibration unit 106 includes: a voice coil 108 for vibrating the vibration unit 106 in cooperation with the magnetic circuit unit 107 arranged within a magnetic gap G (explained later on) of the magnetic circuit unit 107; the diaphragm 114 vibrating with the voice coil 108 to generate a sound; a voice coil bobbin 109 for attaching the voice coil 108 thereto and supporting the diaphragm 114; and a center cap 130 attached to the voice coil bobbin 109.

The magnetic circuit unit 107 includes: a yoke plate 117 made of magnetic material formed in a ring-shape facing to the damper 111 in a vibration direction of the diaphragm 114; a magnet 116 attached to the yoke plate 117; and a yoke 115 made of magnetic material being attached to the magnet 116 for forming a magnetic gap G for generating a magnetic flux to drive (i.e. vibrate) the vibration unit 106 between the yoke plate 117 and the yoke 115.

The damper 111 is arranged between the diaphragm 114 and the magnetic circuit unit 107. The damper 111 is attached to the voice coil bobbin 109. The damper 111 allows the voice coil bobbin 109 to vibrate with the diaphragm 114 and gradually attenuates the vibration of the diaphragm 114 and voice coil bobbin 109.

When the voice coil 108 is supplied with a voice current so that the voice coil bobbin 109 vibrates the diaphragm 114 in response to the voice current, the speaker 101 constructed as described above generates a sound according to the voice current from the diaphragm 114, that is, from the vibration unit 106.

So far, two kinds of method have been used as a method of connecting the voice coil 108 described above to a terminal for connecting to the outside. As shown in FIG. 1, one is a method in which a brocaded thread wire 121 is sewn into the diaphragm 114, the voice coil 108 is set on along the diaphragm 114, and the brocaded thread wire 121 is brazed to the voice coil 108 by using solder or the like. As shown in FIG. 2, the other is a method in which a brocaded thread wire 121 is set between the diaphragm 114 and the damper 111, and the brocaded thread wire 121 is brazed to the voice coil 108 by using solder or the like on an outer peripheral surface of the voice coil bobbin 109.

The diaphragm 114 described above is generally made of electrically insulating material. However, a diaphragm made of metal has been used increasingly, since it is excellent in terms of stiffness and acoustic characteristics (for example, see Japanese Patent Application Laid-Open No. H08-047090). In such a case, a brocaded thread wire 121 cannot be sewn into a diaphragm 114 shown in FIG. 1. Also, in a case that a diaphragm 114 is made of electrically insulating material, in the method shown in FIG. 1 a voice coil 108 must be pulled out to a diaphragm 114 and trained to a position being sewn into, causing a problem that the operation steps are complicated. Further, non-uniform weight is applied on the diaphragm 114, causing a problem that the quality of reproduced sound is affected.

Moreover, in the connection method of the voice coil 108 and the brocaded thread wire 121 shown in FIG. 2, in a case that the diaphragm 114 is made of metal, since a distance for insulation is needed between the diaphragm 114 and the brocaded thread wire 121, therefore there is a disadvantage that the depth dimension of the speaker 101 becomes large. Further, since a neck part of the diaphragm 114 might undesirably come in contact with the brocaded thread wire 121 due to unevenness of the dimension in the height direction of the diaphragm 114, therefore a short circuit might undesirably occur for the brocaded thread wire 121. Even if the diaphragm 114 is made of electrically insulating material, in the connection method shown in FIG. 2, since the brocaded thread wire 121 is directly connected to the voice coil 108 from a terminal 105, therefore the length of the brocaded thread wire 121 becomes large. If the length of the brocaded thread wire 121 is large, when the vibration unit 106 vibrates, the brocaded thread wires 121 come in contact with each other, causing possible disconnection.

In order to solve the problems described above, there may be a solution in which the damper is provided with a hole so that the brocaded thread wire 121 being passed through the hole is directly connected to the voice coil. However, if such a hole is made at the center of an inner edge part and outer edge part of the damper, a slack part of the brocaded thread wire 121 occurs in a space between the damper and the magnetic circuit unit.

If such a slack part of the brocaded thread wire 121 occurs in a space between the damper and the magnetic circuit unit, when the vibration unit vibrates to the side of the magnetic circuit unit, the slack part of the brocaded thread wire 121 abuts against a plate or frame of the magnetic circuit unit, causing a problem that the amplitude of the vibration unit cannot be set large.

### SUMMARY OF THE INVENTION

It is therefore the first objective of the present invention to solve the above problems and to provide a speaker in which a diaphragm made of electrically conductive material can be securely insulated from a brocaded thread wire. The second objective of the present invention is to provide a speaker in which a compact design can be attained so as to make it possible to have a large amplitude for the vibration unit.

In order to attain the first objective, the present invention is to provide a speaker including:

a diaphragm made of electrically conductive material which vibrates to generate a sound;

a voice coil for vibrating the diaphragm by being supplied with a voice current;

a voice coil bobbin around which the voice coil is wound;

a damper for supporting the voice coil bobbin;

a magnetic circuit unit for vibrating the diaphragm in cooperation with the voice coil; and

a brocaded thread wire for supplying the voice current to the voice coil,

wherein the brocaded thread wire is passed through a through hole formed in the damper, wherein a connection part for connecting the brocaded thread wire to the voice coil is arranged on an outer peripheral surface of the voice coil bobbin and the connection part is arranged nearer to the magnetic circuit unit than the damper is.

In order to attain the second objective, the present invention is to provide a speaker including:

a diaphragm which vibrates to generate a sound;

a voice coil for vibrating the diaphragm by being supplied with a voice current;

a voice coil bobbin around which the voice coil is wound;

a damper for supporting the voice coil bobbin;

a magnetic circuit unit for vibrating the diaphragm in cooperation with the voice coil; and

a brocaded thread wire for supplying the voice current to the voice coil,

wherein the brocaded thread wire is passed through a through hole formed in an inner edge part of the damper, the inner edge part being situated in the proximity of the voice coil bobbin, wherein a connection part for connecting the brocaded thread wire to the voice coil is arranged on an outer peripheral surface of the voice coil bobbin, the connection part is arranged nearer to the magnetic circuit unit than the damper is, and the connection part is formed at an end part of the voice coil bobbin, the end part being situated in the proximity of the damper.

### BRIEF DESCRIPTION OF THE DRAWINGS

FIG. 1 is a cross sectional view of a conventional speaker;

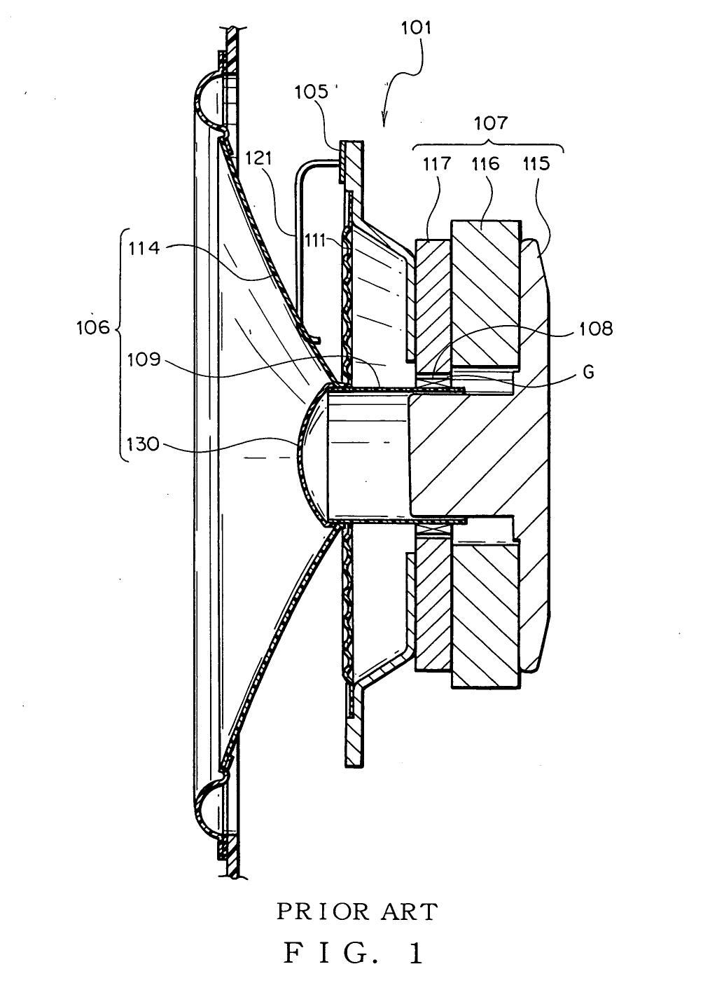

FIG. 2 is a cross sectional view of another conventional speaker; and

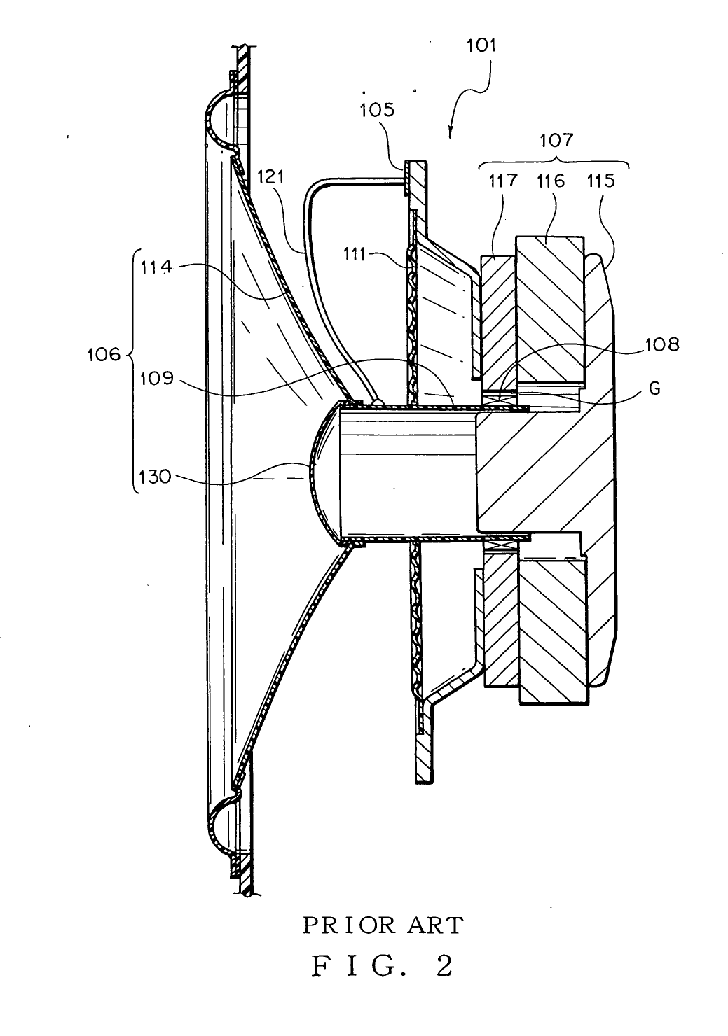

FIG. 3 is a cross sectional view of a speaker according to a preferred embodiment of the present invention.

### DESCRIPTION OF THE PREFERRED EMBODIMENTS

In the following, a speaker according to a preferred embodiment of the present invention is explained. In a speaker according to a preferred embodiment of the present invention, a brocaded thread wire is passed through a through hole formed in a damper, a connection part for connecting the brocaded thread wire to a voice coil is arranged on an outer peripheral surface of a voice coil bobbin, and the connection part is arranged nearer to a magnetic circuit unit than the damper is. The damper made of electrically insulating material is put between a metallic diaphragm and the brocaded thread wire, thereby preventing the metallic diaphragm from coming in contact with the brocaded thread wire. That is, the diaphragm is securely prevented from coming in contact with the brocaded thread wire.

In the speaker according to the present invention, the through hole may be formed in an inner edge part of the damper, wherein the inner edge part is situated in the proximity of the voice coil bobbin.

Further, in the speaker according to the present invention, the connection part for connecting the brocaded thread wire to the voice coil may be formed at an end part of the voice coil bobbin, wherein the end part is situated in the proximity of the damper.

In a speaker according to another preferred embodiment of the present invention, the brocaded thread wire is passed through a through hole formed in an inner edge part of the damper, wherein the inner edge part is situated in the proximity of the voice coil bobbin, a connection part for connecting the brocaded thread wire to the voice coil is arranged on an outer peripheral surface of the voice coil bobbin and the connection part is arranged nearer to the magnetic circuit unit than the damper is, and the connection part is formed at an end part of the voice coil bobbin, wherein the end part is situated in the proximity of the damper. Thereby, a slack part of the brocaded thread wire occurring in a space between the damper and the magnetic circuit unit can be decreased and the amplitude of the vibration unit can be set large.

### EXAMPLES

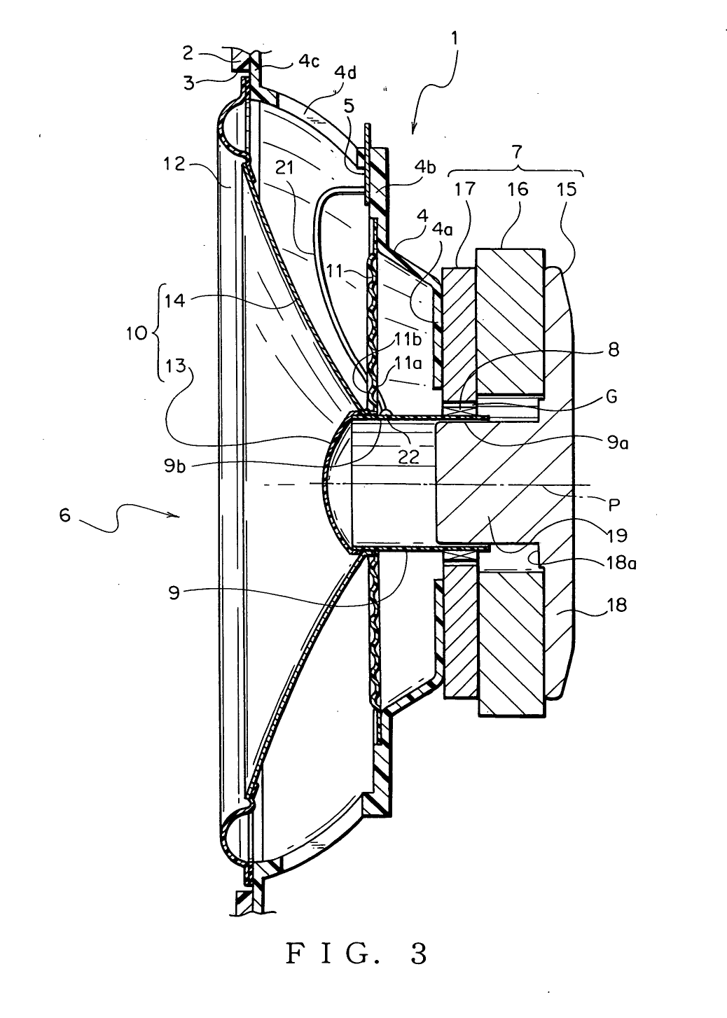

A preferred embodiment of the present invention is explained with reference to FIG. 3. A speaker 1 according to a preferred embodiment of the present invention is attached to a frame such as a box arranged on a floor or a speaker-attaching member 2 such as a rear tray and door panel as an on-vehicle speaker for generating a sound. The speaker-attaching member 2 is provided with a hole 3 for exposing a diaphragm unit 10 of the speaker 1.

As shown in FIG. 3, the speaker 1 includes a vibration unit 6, brocaded thread wire 21, magnetic circuit unit 7 for vibrating the vibration unit 6 so that the vibration unit 6 generates a sound, and a case 4.

The vibration unit 6 includes a voice coil 8, voice coil bobbin 9, diaphragm unit 10, damper 11, edge 12, center cap 13 and so on. The voice coil 8 is arranged coaxially with both of a yoke 15 (explained later on) and yoke plate 17 (explained later on) of the magnetic circuit unit 7 within a magnetic gap G (explained later on) of the magnetic circuit unit 7. A voice current is supplied to the voice coil 8 through the brocaded thread wire 21. When a voice current is supplied to the voice coil 8, the voice coil 8 vibrates a diaphragm unit 10 (i.e. vibrates the vibration unit 6) along an axis P in cooperation with the magnetic circuit unit 7. The center cap 13 is attached to the voice coil bobbin 9.

The voice coil bobbin 9 is formed in a cylindrical shape. The voice coil bobbin 9 is arranged coaxially with the yoke 15, yoke plate 17 and voice coil 8. An end part 9a of the voice coil bobbin 9 in a direction of the axis P is inserted in the magnetic gap G. The voice coil 8 is attached to (i.e. wound around) an outer periphery of the end part 9a. The end part 9a is an end part to which the voice coil bobbin 9 is attached.

The voice coil bobbin 9 is supported by the yoke 15 movably along the axis P (shown with an alternate long and short dash line in FIG. 3) of the yoke 15. The axis P corresponds to a vibration direction of the diaphragm unit 10 (i.e. a vibration direction of the vibration unit 6).

The diaphragm unit 10 includes: a thin plate-shaped center cap 13 having an arc-shape in section and a disc-shape in plan view; and a thin plate-shaped diaphragm 14 having a circular truncated cone shape in side view and an annular shape in plan view. The diaphragm 14 is made of metal as electrically conductive material. The diaphragm 14 is arranged coaxially with the center cap 13 (i.e. arranged coaxially with the yoke 15). An inner edge part of the diaphragm 14 is attached to an opposite end part 9b of the voice coil bobbin 9. The opposite end part 9b is an end part of the voice coil bobbin 9, wherein the opposite end part 9b is situated in the proximity of the damper 11. The diaphragm 14 vibrates to generate a sound. An outer edge part of the center cap 13 is attached to the diaphragm 14 and the voice coil bobbin 9 in such a manner that the center cap 13 closes the voice coil bobbin 9.

The damper 11 is made of electrically insulating material and formed in a thin plate-shape having an annular shape in plan view. An inner edge part 11b of the damper 11 is attached to the opposite end part 9b of the voice coil bobbin 9. An outer edge part of the damper 11 is attached to an inner surface of the case 4. The inner edge part 11b situated in the proximity of the voice coil bobbin 9 is provided with a through hole 11a. The brocaded thread wire 21 is passed through the through hole 11a. The damper 11 allows the diaphragm 14 of the diaphragm unit 10 to vibrate along the axis P and gradually attenuates the vibration of the diaphragm 14 of the diaphragm unit 10.

The edge 12 is formed in a thin plate-shape having an annular shape in a plan view. An inner edge part of edge 12 is attached to an outer edge part of the diaphragm 14. An outer edge part of the edge 12 is attached to an outer edge part 4c of the frame (case) 4 situated inside a hole 3 of the speaker-attaching member 2. The edge 12 allows the diaphragm 14 of the diaphragm unit 10 to vibrate along the axis P and gradually attenuates the vibration of the diaphragm 14 of the diaphragm unit 10.

The brocaded thread wire 21 is passed through the through hole 11a formed in the inner edge part 11b of the damper 11 in the proximity of the voice coil bobbin 9. An end part of the brocaded thread wire 21 is connected to the voice coil 8 on an outer peripheral surface of the opposite end part 9b of the voice coil bobbin 9 in the proximity of the damper 11, while an opposite end part of the brocaded thread wire 21 is connected to a terminal 5 on the frame (case) 4. The brocaded thread wire 21 is connected to the voice coil 8 and a terminal 5 (not shown in the figure) by brazing with a solder or the like. Therefore, on an outer peripheral surface of the opposite end part 9b of the voice coil bobbin 9, there is provided a connection part 22 consisting of solder or the like, which connects the brocaded thread wire 21 and the voice coil 8 to each other.

The magnetic circuit unit 7 includes the yoke 15 consisting of magnetic material (i.e. paramagnetic material or ferromagnetic material), magnet 16, and a yoke plate 17 consisting of magnetic material (i.e. paramagnetic material or ferromagnetic material). The yoke 15 integrally includes a disc-shaped bottom plate 18 and a cylindrical center pole 19, which stands up from the center of the bottom plate 18 and is arranged coaxial with the bottom plate 18.

An outer diameter of the bottom plate 18 is larger than that of the center pole 19. The yoke 15 is arranged so that an end part of the center pole 19 on the side situated away from the bottom plate 18 enters the inside of the end part 9a of the voice coil bobbin 9. A portion 18a of the bottom plate 18 located near to the center pole 19 faces the end part 9a of the voice coil bobbin 9 along the axis P.

The magnet 16 is formed in an annular shape. The magnet 16 may be a permanent magnet or a magnet that is magnetized with a direct-current power supply. On a condition that the center pole 19 of the yoke 15, the end part 9a of the voice coil bobbin 9 and voice coil 8 enter the inside of the magnet 16, the magnet 16 is piled up on the bottom plate 18 of the yoke 15 so that the magnet 16 is attached to the yoke 15.

The yoke plate 17 is formed in an annular shape. On a condition that the center pole 19 of the yoke 15 enters the inside of the yoke plate 17, the yoke plate 17 is piled up on the magnet 16. The yoke plate 17, magnet 16 and yoke 15 are fixed to each other. The yoke plate 17, magnet 16 and yoke 15 are arranged coaxially with each other. There is an interval between an outer peripheral surface of the center pole 19 and an inner peripheral surface of the yoke plate 17.

According to the construction described above, the magnetic circuit unit 7 is constructed in a so-called outer magnet type. The magnetic circuit unit 7 has a magnetic gap G between the outer peripheral surface of the center pole 19 and the inner peripheral surface of the yoke plate 17, wherein the gap G is provided to generate magnetic flux for driving (vibrating) the diaphragm unit 10 in cooperation with the voice coil 8.

The frame (case) 4 is made of non-magnetic material such as resin or aluminum and formed in an annular shape. The case 4 is arranged coaxially with both of the vibration unit 6 and the magnetic circuit unit 7. An inner edge part 4a of the frame 4 is piled up on the yoke plate 17 so that the frame 4 is attached to the yoke plate 17. The frame 4 is provided with a flat damper-attaching step 4b, to which an outer edge part of the damper 11 is attached.

Therefore, the inner edge part 4a of the frame 4 is arranged between the damper 11 and the magnet 16. The inner edge part 4a of the case 4 faces the damper 11 along the axis P. An outer edge part 4c of the frame 4 is attached to the speaker-attaching member 2 and to an outer edge part of the edge 12. An opening 4d is formed on a specific portion for connecting a damper-attaching step 4b and an outer edge part 4c of the frame 4, so that when the speaker 1 is driven, air in a space on the rear side of the diaphragm 14 is being set free, thereby preventing the rear pressure of the diaphragm 14 from increasing.

In the speaker 1 thus constructed, a voice current is supplied to the voice coil 8, so that the voice coil 8 held within a magnetic gap G vibrates along the axis P in response to the voice current. Then, the voice coil bobbin 9 that supports the voice coil 8 vibrates along the axis P together with the center cap 13 and the diaphragm 14 of the diaphragm unit 10, so that the center cap 13 and the diaphragm 14 generate a sound according to the voice current. Thus, the magnetic circuit unit 7 vibrates the diaphragm unit 10 (i.e. vibrates the vibration unit 6) so as to generate a sound.

According to the preferred embodiment, even if the diaphragm 14 is made of metal as electrically conductive material, since the damper 11 being put between the diaphragm 14 and the brocaded thread wire 21 functions as an electrical insulator, therefore the speaker 1 can be provided, in which the diaphragm 14 can be securely electrically insulated from the brocaded thread wire 21.

Further, since the brocaded thread wire 21 is passed through the through hole 11a formed in the inner edge part 11b of the damper 11 in the proximity of the voice coil bobbin 9 and the connection part 22 is provided at the opposite end part 9b in the proximity of the damper 11, therefore, a slack of the brocaded thread wire 21 is decreased in a space between the damper 11 and the magnetic circuit unit 7. That is, a slack of the brocaded thread wire 21 can be prevented from occurring. Therefore, when the vibration unit 6 vibrates and approaches to the magnetic circuit unit 7-side, a problem that a slack of the brocaded thread wire 21 abuts against the magnetic circuit unit 7 can be avoided, therefore the vibration unit 6 can secure large amplitude. Moreover, since the damper 11 is put between the diaphragm 14 and the brocaded thread wire 21 so that the damper 11 functions as an electrical insulator, therefore it is not necessary to form a distance between diaphragm 14 and the brocaded thread wire 21 for the purpose of electrical insulation. Accordingly, a speaker 1 having high quality of sound and compact design can be provided, in which speaker 1 the amplitude of the vibration unit 6 is large.

In the preferred embodiment described above, the speaker 1 is constructed in a so-called outer magnet type. However, in the present invention, the speaker 1 may be constructed in a so-called inner magnet type instead.

In the preferred embodiment described above, the through hole 11a is formed in the inner edge part 11b of the damper 11 and the connection part 22 is formed on the opposite end part 9b of the voice coil bobbin 9. However, in the present invention, such construction is not necessarily required. In the present invention, if the diaphragm 14 is made of electrically conductive material, the brocaded thread wire 21 is passed through a through hole 11a formed at any position of the damper 11, and the connection part 22 is formed on an outer peripheral surface of the voice coil bobbin 9 at any position between the damper 11 and the magnetic circuit unit 7.

In the preferred embodiment described above, the diaphragm 14 is made of metal as electrically conductive material. However, in the present invention, the diaphragm 14 may be made of electrically insulating material instead. In the present invention, if the diaphragm 14 is made of electrically insulating material, the through hole 11a is formed in the inner edge part 11b of the damper 11 and the connection part 22 is formed at the opposite end part 9b of the voice coil bobbin 9.

According to the EXAMPLES described above, the following speaker 1 can be obtained.

(Additional Remark 1)

A speaker 1 including:

a diaphragm 14 made of electrically conductive material which vibrates to generate a sound;

a voice coil 8 for vibrating the diaphragm 14 by being supplied with a voice current;

a voice coil bobbin 9 around which the voice coil 8 is wound;

a damper 11 for supporting the voice coil bobbin 9;

a magnetic circuit unit 7 for vibrating the diaphragm 14 in cooperation with the voice coil 8; and

a brocaded thread wire 21 for supplying the voice current to the voice coil 8,

wherein the brocaded thread wire 21 is passed through a through hole 11a formed in the damper 11, wherein a connection part 22 for connecting the brocaded thread wire 21 to the voice coil 8 is arranged on an outer peripheral surface of the voice coil bobbin 9 and the connection part 22 is arranged nearer to the magnetic circuit unit 7 than the damper 11 is.

(Additional Remark 2)

The speaker 1 as described in the Additional Remark 1, wherein the through hole 11a is formed in an inner edge part 11b of the damper 11, the inner edge part 11b being situated in the proximity of the voice coil bobbin 9.

(Additional Remark 3)

The speaker 1 as described in the Additional Remark 1 or 2, wherein the connection part 22 is formed at an end part 9b of the voice coil bobbin 9, the end part 9b being situated in the proximity of the damper 11.

(Additional Remark 4)

A speaker 1 including:

a diaphragm 14 which vibrates to generate a sound;

a voice coil 8 for vibrating the diaphragm 14 by being supplied with a voice current;

a voice coil bobbin 9 around which the voice coil 8 is wound;

a damper 11 for supporting the voice coil bobbin 9;

a magnetic circuit unit 7 for vibrating the diaphragm 14 in cooperation with the voice coil 8; and

a brocaded thread wire 21 for supplying the voice current to the voice coil 8,

wherein the brocaded thread wire 21 is passed through a through hole 11a formed in an inner edge part 11b of the damper 11, the inner edge part 11b being situated in the proximity of the voice coil bobbin 9, wherein a connection part 22 for connecting the brocaded thread wire 21 to the voice coil 8 is arranged on an outer peripheral surface of the voice coil bobbin 9, the connection part 22 is arranged nearer to the magnetic circuit unit 7 than the damper 11 is, and the connection part 22 is formed at an end part 9b of the voice coil bobbin 9 in the proximity of the damper 11.

The aforementioned EXAMPLES are described to aid in understanding of the present invention. Therefore, the present invention is not limited to the EXAMPLES. That is, variations may be made by one skilled in the art without departing from the spirit and scope of the present invention.

Incidentally, the contents of Japanese Patent Application No. 2005-158694 are hereby incorporated by reference.

What is claimed is:

1. A speaker comprising:
a diaphragm made of electrically conductive material which vibrates to generate a sound;
a voice coil for vibrating the diaphragm by being supplied with a voice current;
a voice coil bobbin around which the voice coil is wound;
a damper for supporting the voice coil bobbin;
a magnetic circuit unit for vibrating the diaphragm in cooperation with the voice coil; and
a brocaded thread wire for supplying the voice current to the voice coil,
wherein the brocaded thread wire is passed through a through hole formed in the damper, wherein a connection part for connecting the brocaded thread wire to the voice coil is arranged on an outer peripheral surface of the voice coil bobbin and the connection part is arranged nearer to the magnetic circuit unit than the damper is.

2. The speaker according to claim 1, wherein the through hole is formed in an inner edge part of the damper, the inner edge part being situated in the proximity of the voice coil bobbin.

3. The speaker according to claim 1, wherein the connection part is formed at an end part of the voice coil bobbin, the end part being situated in the proximity of the damper.

4. The speaker according to claim 2, wherein the connection part is formed at an end part of the voice coil bobbin, the end part being situated in the proximity of the damper.

5. A speaker comprising:
a diaphragm which vibrates to generate a sound;
a voice coil for vibrating the diaphragm by being supplied with a voice current;
a voice coil bobbin around which the voice coil is wound;
a damper for supporting the voice coil bobbin;
a magnetic circuit unit for vibrating the diaphragm in cooperation with the voice coil; and
a brocaded thread wire for supplying the voice current to the voice coil,
wherein the brocaded thread wire is passed through a through hole formed in an inner edge part of the damper, the inner edge part being situated in the proximity of the voice coil bobbin, wherein a connection part for connecting the brocaded thread wire to the voice coil is arranged on an outer peripheral surface of the voice coil bobbin, the connection part is arranged nearer to the magnetic circuit unit than the damper is, and the connection part is formed at an end part of the voice coil bobbin, the end part being situated in the proximity of the damper.
